(19) United States
(12) Patent Application Publication
(10) Pub. No.: US 2016/0143480 A1
(43) Pub. Date: May 26, 2016

(54) Manually Operable Herb Grinder

(71) Applicants: Jim Watts, Winnipeg (CA); Fred Fitzgerald, Winnipeg (CA)

(72) Inventors: Jim Watts, Winnipeg (CA); Fred Fitzgerald, Winnipeg (CA)

(21) Appl. No.: 14/725,598

(22) Filed: May 29, 2015

Related U.S. Application Data
(60) Provisional application No. 62/083,494, filed on Nov. 24, 2014.

(51) Int. Cl. A47J 42/24; A47J 42/46; A47J 42/30

(52) U.S. Cl. CPC A47J 42/24; A47J 42/30; A47J 42/46

(57) ABSTRACT

A manually operable herb grinder features a housing assembled from a plurality of detachable sections, including a drive section for housing drive components and one or more product chamber sections for containing a product. The product chamber is divided into input and output chambers for initially receiving unground product, and catching ground product falling from a grinding area intermediate the two chambers. Blades carried on a shaft in the grinding area are rotated by a planetary gear system, whose input is a rotatable cap installed over the drive section at a top end of the housing. The grinding area is situated between a spoked divider at an upper end of the input chamber, and a perforated divider at the upper end of the output chamber. The cap is rotatable by hand, or by frictional rolling contact against a surface.

### CROSS REFERENCE TO RELATED APPLICATIONS

This application claims benefit under 35 U.S.C. 119(e) of Provisional Application Ser. No. 62/083,494, filed Nov. 24, 2014.

### FIELD OF THE INVENTION

The present invention relates generally to grinders, and more particularly to a handheld manually driven grinder with a unique planetary gear drive through which one or more blades are driven at a grinding area disposed between separated input and output chambers of the grinder housing.

### BACKGROUND

The use of marijuana for treatment of select medical conditions has become more widely known, and legalized of marijuana for medical and/or recreational purpose is becoming more widespread. One example of medical use of marijuana is to ease the pain caused by chronic conditions, such as arthritis. However, use of marijuana presents a particular challenge to those afflicted with arthritis, as grinding or cutting of marijuana buds can be difficult or impossible with arthritic hands using conventional tools.

Applicant has developed a unique manually operated grinder that requires little physical effort with minimal hand movements, and provides excellent grinding results. Although motivation for the invention was derived from a desire to help medical marijuana users, the grinder may alternatively be used for other purposes, including use on other herbs or products that benefit from or require a grinding action before consumption, for example tobacco or edible herbs.

Examples of prior art grinders and cutters for various purposes include an electrically powered condiment grinder in UK Patent GB2452343, a manually operated food pulverizer in U.S. Pat. No. 7,059,553 and U.S. Pat. No. 7,422,169, a tobacco grinder in U.S. Pat. No. 8,393,563, a pepper grinder in U.S. Pat. No. 8,444,074, and a clump breaker in U.S. Pat. No. 8,701,941.

Although these references share some features in common with the product developed by the Applicant, they fail to disclose or suggest a number of unique features and combinations of the Applicant's invention.

### SUMMARY OF THE INVENTION

According to a first aspect of the invention, there is provided a manually operable grinder comprising:

a housing comprising:
a drive chamber for housing drive components;
a product chamber for containing a product;

a rotatable upper cap at an upper end of the housing and rotatable relative thereto about a longitudinal thereof;

a gear carrier comprising:
a drive end coupled to the rotatable upper cap for driven rotation of the gear carrier about the longitudinal axis under rotation of the upper cap; and
inside the drive chamber, a plurality of stub shafts spaced angularly apart from one another about the longitudinal axis in orientations lying parallel thereto;

a gear train comprising:
a respective planetary gear disposed about each stub shaft in a manner rotatable about an axis thereof;
a sun gear disposed within the interior space of the drive section at a position centred on the longitudinal axis and in engagement with the plurality of planetary gears;
a ring gear located inside the drive chamber at a position centered around the longitudinal axis with teeth of said ring gear facing inwardly toward the longitudinal axis in engagement with the plurality of planetary gears;

a main shaft having an upper end coupled to the sun gear for rotation therewith and extending downward therefrom into the product chamber; and

at least one blade coupled to the main shaft and radiating outwardly therefrom for rotation therewith, whereby rotation of the end cap rotates the gear carrier in order to drive rotation of the main shaft and the at least one blade via the gear assembly in order to perform a grinding operation on the product in the product chamber.

Preferably the drive chamber is defined by a respective drive section of the housing that is removably coupled to one or more product chamber sections defining the product chamber.

Preferably the product chamber is divided into input and output chambers, the input chamber being disposed adjacent the drive chamber for receiving a product in an unground state, and the output chamber being disposed across the input chamber from the drive chamber in order to receiving the product in a ground state after performance of the grinding operation on the product by the at least one blade.

Preferably the input and output chambers are respectively defined by input and output chamber sections of the housing that are removably coupled to one another.

Preferably the input chamber comprises a spoked divider that is located adjacent an upper end thereof that resides opposite the output chamber, the spoked divider comprises a series of spokes radiating outwardly away from the longitudinal axis toward the circumferential wall of the input chamber section at angularly spaced locations around the longitudinal axis leaving open areas between said spokes, and the at least one blade comprises one or more blades residing between the spoked divider and the output chamber.

Preferably said one or more blades comprise two sets of blades disposed in different respective cutting planes, each set of blades comprising a pair of radially opposing blades.

Preferably, each set of blades consists only of said pair of radially opposing blades.

Preferably, said one or more blades residing between the spoked divider and the output chamber are the only blades of the grinder.

Preferably there is provided a perforated divider located between the input and output chambers to allow entry of the ground product to the interior space of the output chamber section while preventing entry of the unground product thereto.

Preferably the perforated divider is defined by a removable divider section of the housing that is coupled between the output chamber and the input chamber.

Preferably the perforated divider comprises a central opening therein in which the main shaft is received.

In one embodiment, the central opening of the perforated divider is a through-hole, and the main shaft comprises an enlarged intermediate portion located above the perforated divider and having a greater diameter than the central opening of the perforated divider to block sliding of the main shaft downwardly through said central opening and thereby locate the at least one blade at a spaced distance from said perforated divider.

Preferably there is provided a removable base at the lower end of the housing.

Preferably there is provided a screen mounted within the product chamber below the at least one blade.

Preferably the screen is clamped in place between the removable base and an adjacent section of the housing to which the removable base is detachably coupled.

Preferably the housing comprises a plurality of detachable sections removably coupled to one another, the detachable sections comprising distinct sets of indicators thereon that provide guidance to a sequential order of the detachable sections in an assembled state of the housing.

Preferably each set of indicators comprises at least one pair of matching indicators defined on an adjacent pair of the detachable sections.

Preferably each indicator comprises a one or more markings, and the distinct sets of indicators are distinguished from one another by a quantity of the one of more markings in each indicator of the set.

Preferably aligned and misaligned states between the indicators of each set distinguish between an engaged and disengaged state between coupling features at a respective pair of matable ends of the detachable sections.

Preferably the coupling features of each pair of matable ends of the detachable sections comprise a circumferential tab on one of the detachable sections and a corresponding circumferential slot on another of the detachable sections, the tab being axially insertable into the circumferential slot by relative axial displacement between the detachable sections, and circumferentially slidable along the circumferential slot by relative rotation between the detachable sections to engage and disengage the detachable sections to and from one another.

Preferably the housing comprises a plurality of detachable sections removably coupled to one another, and the main shaft is maintained in position solely by a coupled-together state of the detachable sections.

According to a second aspect of the invention, there is provided manually operable grinder comprising:

a housing comprising a plurality of housing sections each having an upper end and an opposing lower end and a circumferential wall spanning around a longitudinal axis of the housing to enclose an interior space of said housing section between the upper and lower ends thereof, the plurality of housing sections comprising:
a drive section for housing drive components;
an input chamber section for receiving a product in an unground state, the upper end of the input chamber section being coupled to the lower end of the drive section; and
an output chamber section for receiving the product in a ground state after a grinding operation;

a rotatable upper cap disposed over the upper end of the drive section and rotatable relative thereto about the longitudinal axis;

a gear carrier comprising:
a drive end coupled to the rotatable upper cap for driven rotation of the gear carrier about the longitudinal axis under rotation of the upper cap; and
inside the interior space of the drive section of the housing, a plurality of stub shafts spaced angularly apart from one another about the longitudinal axis in orientations lying parallel thereto;

a gear system comprising:
a respective planetary gear disposed about each stub shaft in a manner rotatable about an axis thereof;
a sun gear disposed within the interior space of the drive section at a position centred on the longitudinal axis and in engagement with the plurality of planetary gears;
a ring gear located inside the interior space of the drive section a position centered around the longitudinal axis with teeth of said ring gear facing inwardly toward the longitudinal axis in engagement with the plurality of planetary gears;

a main shaft having an upper end coupled to the sun gear for rotation therewith and extending downward therefrom into the input chamber section; and

at least one blade coupled to the main shaft and radiating outwardly therefrom for rotation therewith, whereby manual rotation of the end cap rotates the gear carrier in order to drive rotation of the main shaft and the at least one blade via the gear assembly in order to perform the grinding operation on the unground product in the input product chamber in order to create the ground product in the output product chamber.

According to a third aspect of the invention, there is provided grinder comprising:

a housing comprising an input chamber receiving a product in an unground state, and an output chamber section for receiving the product in a ground state after performance of a grinding operation;

a shaft lying on a longitudinal axis the housing;

a drive mechanism coupled to the shaft and operable to drive rotation thereof about the longitudinal axis;

at least one blade coupled to the main shaft and radiating outwardly therefrom for rotation therewith at an intermediate plane disposed between the input chamber and the output chamber;

a first divider located above the intermediate plane in which the at least one blade resides;

a second divider below the intermediate plane in which the at least one blade resides;

wherein the first divider has openings therein of a first size and the second divider has openings therein of a smaller second size such that unground product can reach the intermediate plane through the openings of the first size for performance of a grinding operation of the unground product by said blades, but the unground product cannot pass through the openings of the second size to the output chamber until ground into smaller pieces by the at least one blade of the intermediate plane.

In one embodiment, there is provided at least one additional blade coupled to the main shaft and radiating outwardly therefrom for rotation therewith at a location closely adjacent the first divider on a side thereof opposite the intermediate plane.

Preferably the first divider comprises a spoked divider comprising a series of spokes radiating outwardly away from the longitudinal axis toward a circumferential wall of the input chamber at angularly spaced locations around the longitudinal axis, and the openings of the first size comprise open areas between said spokes.

Preferably the second divider comprises plurality of cylindrical through-bores arrayed over an area of said second divider.

According to a fourth aspect of the invention, there is provided a grinder comprising:

a housing comprising a plurality of housing sections each having an upper end and an opposing lower end and a circumferential wall spanning around a longitudinal axis of the housing to enclose an interior space of said housing section between the upper and lower ends thereof, the plurality of housing sections comprising a drive section for housing drive components and a product chamber for containing a product;

a main shaft having an upper end coupled to the drive components in the drive section and extending downward therefrom into the product chamber; and

at least one blade coupled to the main shaft and radiating outwardly therefrom for rotation therewith, whereby driven rotation of the main shaft performs a grinding operation on the product in the product chamber;

wherein the detachable sections comprising distinct sets of indicators thereon that provide guidance to a sequential order of the detachable sections in an assembled state of the housing.

According to a fifth aspect of the invention, there is provided a grinder comprising:

a housing comprising a plurality of housing sections each having an upper end and an opposing lower end and a circumferential wall spanning around a longitudinal axis of the housing to enclose an interior space of said housing section between the upper and lower ends thereof, the plurality of housing sections comprising a drive section for housing drive components and a product chamber for containing a product;

a main shaft having an upper end coupled to the drive components in the drive section and extending downward therefrom into the product chamber; and

at least one blade coupled to the main shaft and radiating outwardly therefrom for rotation therewith, whereby driven rotation of the main shaft performs a grinding operation on the product in the product chamber;

wherein the main shaft is maintained in position solely by a coupled-together state of the detachable sections such that disassembly of the housing automatically releases the main shaft and the at least one blade.

According to a sixth aspect of the invention, there is provided a grinder comprising:

a housing comprising a plurality of housing sections each having an upper end and an opposing lower end and a circumferential wall spanning around a longitudinal axis of the housing to enclose an interior space of said housing section between the upper and lower ends thereof, the plurality of housing sections comprising a drive section for housing drive components and a product chamber for containing a product;

a main shaft having an upper end coupled to the drive components in the drive section and extending downward therefrom into the product chamber;

at least one blade coupled to the main shaft and radiating outwardly therefrom for rotation therewith, whereby driven rotation of the main shaft performs a grinding operation on the product in the product chamber; and

coupling features defined at matable ends of the detachable sections for attaching adjacent sections to one another in an assembled state of the housing, said coupling features comprising a circumferential tab on one of the detachable sections and a corresponding circumferential slot on another of the detachable sections, the tab being axially insertable into the circumferential slot by relative axial displacement between the detachable sections, and circumferentially slidable along the circumferential slot by relative rotation between the detachable sections to engage and disengage the detachable sections to and from one another.

### BRIEF DESCRIPTION OF THE DRAWINGS

Preferred embodiments of the invention will now be described in conjunction with the accompanying drawings in which:

FIG. 1 is a partially exploded view of a hand-held manual grinder according to a first embodiment of the present invention, cross-sectioned in a central vertical plane of same.

FIG. 2 is a horizontal cross-section of the hand-held manual grinder of FIG. 1 as viewed along line A-A thereof.

FIG. 3 is a horizontal cross-section of the hand-held manual grinder of FIG. 1 as viewed along line B-B thereof.

FIG. 4 is a horizontal cross-section of the hand-held manual grinder of FIG. 1 as viewed along line C-C thereof.

FIG. 5 is an exploded elevational view of a second embodiment hand-held manual grinder from a first side thereof.

FIG. 6 is an exploded elevational view of the hand-held manual grinder of FIG. 5 from an opposing second side thereof, cross-sectioned in a central vertical plane thereof.

FIG. 7 is a horizontal cross-section of the hand-held manual grinder of FIG. 5 as viewed along line D-D thereof.

FIG. 8 is a horizontal cross-section of the hand-held manual grinder of FIG. 6 as viewed along line E-E thereof.

FIG. 9 is a cross-sectional view of the hand-held manual grinder of FIG. 6, as cross-sectioned in the same central vertical plane, but shown in a fully assembled state.

In the drawings like characters of reference indicate corresponding parts in the different figures.

### DETAILED DESCRIPTION

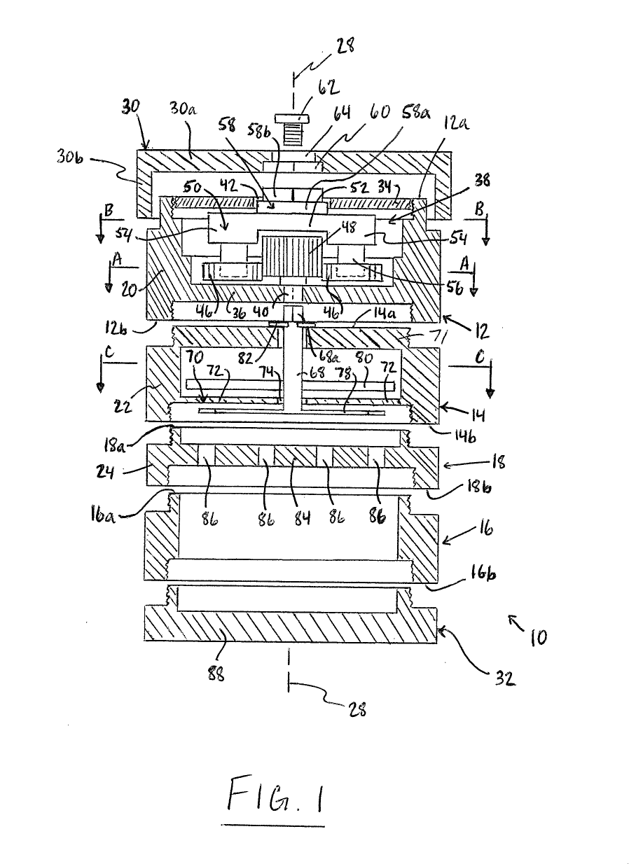

With reference to FIG. 1, a grinder according to one embodiment of the present invention features a housing or container 10 assembled from a number of different housing sections threadingly coupled together end to end to form the overall housing or container. More specifically, a drive section 12 defines a top end of the housing 10, an input chamber section 14 is coupled to the drive section 12, an intermediate section 18 is coupled to the input chamber section 14 at the end thereof opposite the drive section 12, and an output chamber 16 section coupled to the intermediate section at the end thereof opposite the input chamber section. Each of these sections has an upper end 12a, 14a, 16a, 18a, an opposing lower end 12b, 14b, 16b, 18b, and a respective circumferential wall 20, 22, 24, 26 that closes concentrically around a central longitudinal axis 28 shared by all the housing sections when coupled together to form the overall housing 10. Each circumferential wall marks the circumferential boundary of an interior space of the respective housing section around the central longitudinal axis 28.

A rotatable cap 30 fits over the upper end 12a of the drive section 12 at the top the housing and is rotatable relative thereto about the longitudinal axis 28 in order to define a manually operated actuator for driving a grinding mechanism of the grinder. As described in more detail further below, the output chamber section 16 may have a removable base coupled to the lower end 16b thereof to define the bottom end of the overall housing when in place.

The interior space of the drive section 12 holds a number of drive components used to drives blades that perform a grinding action on marijuana buds, or another herb product, that is placed in the interior space of the input chamber section 14 by a user. A removable closure disc 34 features external threads at an outer circumference thereof for mating with corresponding internal threads formed on the circumferential wall 20 of the drive section 12 at the upper end 12a thereof. A floor 36 of the drive section 12 lies in a plane perpendicular to the longitudinal axis 28 at a location nearer to the bottom end 12b of the drive section than the top end 12a thereof, whereby the floor 36 and the closure disc 34 define parallel top and bottom boundaries of an internal chamber of the drive section 12, which houses select drive components of the grinder and is thus referred to herein as a drive chamber 38. Aside from a central through-hole 40 passing through the floor 36 on the central longitudinal axis 28, the floor closes off the entire bottom end of the drive chamber. Likewise, aside from a central through-hole 42 passing through the closure disc 34 on the central longitudinal axis 28, the closure disc 34 closes off the entire top end of the drive chamber.

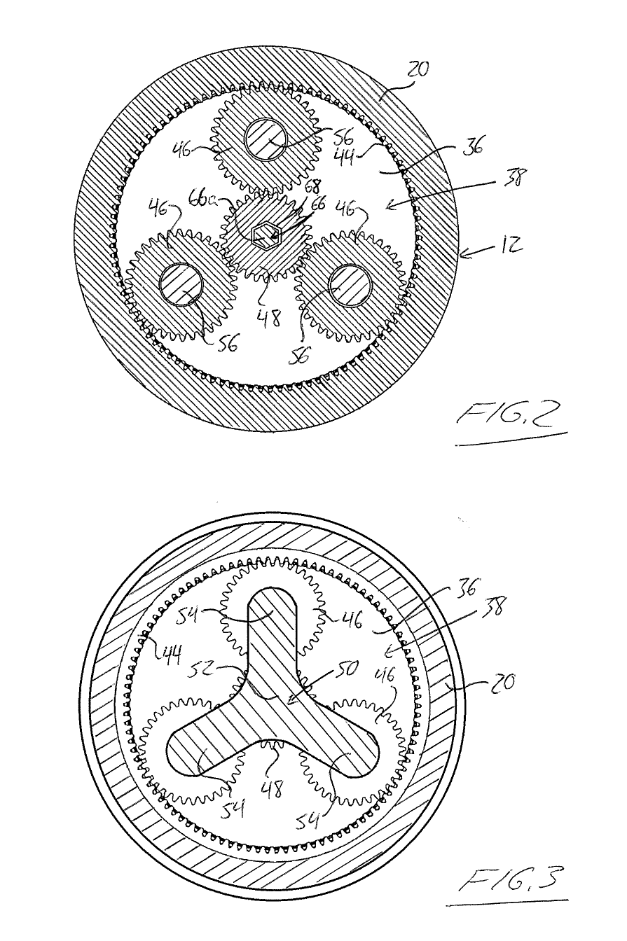

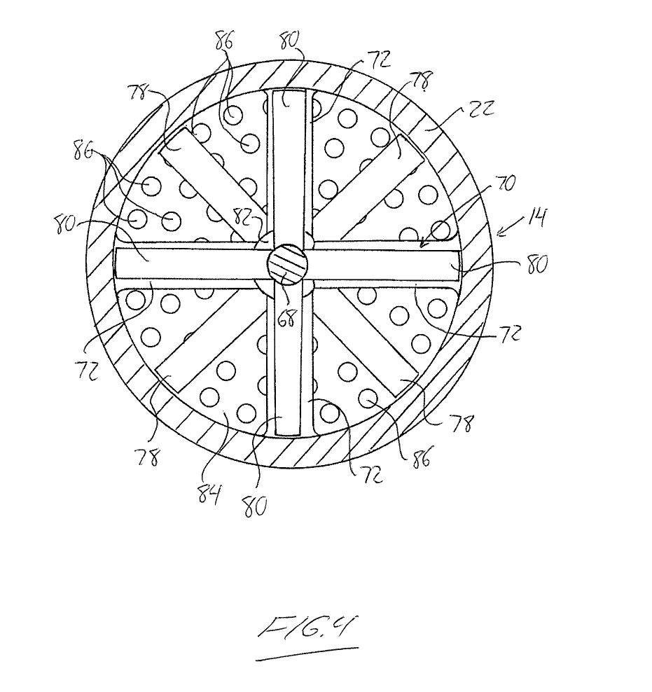

Above the floor 36 of the drive chamber 38, the circumferential wall 20 therearound features gear teeth projecting radially inward toward the longitudinal axis 28, whereby the circumferential wall 20 defines a ring gear 44 that is cooperable with a set of planetary gears 46 received within the drive chamber, as best shown in FIG. 2. The planetary gears, of which there are three in the illustrated embodiments, but which may vary in number, are seated atop the floor 36 of the drive chamber 38, and are slidable thereover for both rotation about their own own axes and revolution around the central longitudinal axis on which a sun gear 48 is centered. The sun gear 48 is also seated atop the floor 36, and is rotatable about its own axis, which coincides with the central longitudinal axis 28. The teeth of the planetary gears 46 mesh with the teeth of the ring gear 44, and also with the teeth of the sun gear 48, thereby forming a planetary gear train centered on the longitudinal axis 28.

In a plane lying normal to the longitudinal axis 28 within the drive chamber at a short height above the planetary gear train, a gear carrier 50 features a central connecting hub 52 overlying the sun gear 48, and three radial arms 54 emanating outwardly from the connecting hub 52 to positions overlying the three planetary gears 46. A respective stub-shaft 56 depends downwardly from the underside of each radial arm 54 into a central opening of a respective one of the planetary gears 46, whereby the planetary gear 46 closes around the stub shaft and is rotatable about the axis thereof, which lies parallel to the central longitudinal axis 28 of the container at a radial distance outward therefrom. As an alternative to being seated atop the floor of the drive chamber, the planetary gears may be suspended a short height thereover by the stub shafts of the gear carrier.

Atop the connecting hub 52 that joins together the radial arms 54, the gear carrier 50 features a central drive hub 58 projecting axially upward from the connecting hub 52 on the central longitudinal axis 28. The drive hub 58 reaches upwardly out of the drive chamber 38 through the central opening 42 in the closure disc 34. A lower portion 58a of the drive hub 58 that passes through the closure disc 34 may be cylindrical in shape with a smooth circumferential wall for smooth rotation of the drive hub 38 within the circular opening 42 of the closure disc 34. A top portion 58b of the drive hub is hexagonal in plan view, thus having its periphery divided into six flat segments connected end-to-end around the central longitudinal axis 28. The roof 30a of the cap 30 has a slightly larger hexagonal recess 60 in the underside thereof at the central longitudinal axis L, such that the hexagonal top end of the drive hub 58 fits matingly into this hexagonal recess 60 in the cap, whereby rotation of the cap 30 will drive rotation of the gear carrier 50. This drives revolution of the planetary gears 46 about the longitudinal axis 28, which due to the meshed relationship of the planetary gears with the ring gear 44 and sun gear 48, will drive rotation of the sun gear 48 about the longitudinal axis 28. The cap 30 thus forms a manually operable drive member for operating the gear train, in which the planetary gears serve as the input gears, the sun gear serves as the output gear, and the ring gear is stationary as an integral component of the stationary drive section of the housing. In other embodiments, the ring gear may be a non-integral component that is fixed or otherwise retained in the drive section in a non-rotatable condition. A screw fastener 62 couples the cap 30 to the gear carrier 52 by engaging into an threaded hole in the top end of the drive hub 58 through a central opening 64 in the topside of the cap roof 30a that communicates with the hexagonal recess 60 in the underside of the cap roof.

A cylindrical periphery wall 30b depends downward from the roof 30a of the cap around the outside of the circumferential wall 20 of the drive section 12 of the housing. As shown, the outer diameter of the drive section's circumferential wall may be stepped down at the upper end 12a of the drive section to reduce or omit any radial extension of the cap's peripheral wall beyond the outer circumference of the drive section. Likewise, the outer diameter at the upper ends 14a, 16a, 18a of the other housing sections 14, 16, 18 are stepped down relative to the remainder of the circumferential walls thereof, whereby a common outer diameter shared by these remainders of the circumferential walls defines a uniform outer diameter of the housing from the bottom end thereof to the cap in the fully assembled state of the housing, where the stepped down areas at the top of these sections each define a male end that fits into the female bottom end of the next section moving upwardly toward the cap. The outer surface of the cap's peripheral wall 30b forms a gripping surface by which the cap can be easily grasped and rotated, or which can be placed against a surface and rolled therealong to drive rotation of the cap. The outer surface of the cap's peripheral wall preferably textured, or ribbed for easier manual gripping, or for improved frictional engagement with a surface on which the cap is being rolled.

A grinding mechanism of the grinder features a main shaft 68 lying on the central longitudinal axis 28. An upper portion 68a of the main shaft 68 at the top end thereof is hexagonally shaped in plan view, thus having six flat facets or segments at its periphery that close around the longitudinal axis 28. A recess of slightly larger hexagonal cross-section extends axially into the sun gear 48 from the lower end thereof, and matingly receives the hexagonal upper portion 62a of the main shaft 62, as best shown in FIG. 2. As a result, rotation of the sun gear 48 causes the main shaft 68 to rotate therewith. Although the illustrated embodiments employ hexagonal shapes at both the interface between the cap and the gear carrier and the interface between the sun gear and main shaft, other shapes capable of providing such rotational coupling between components may instead be employed, including, but not-limited to other polygonal shapes (e.g. rectangular, triangular, pentagonal, octagonal, etc.). From its rotation-transmitting connection to the sun gear 48, the main shaft 68 extends downward into the input chamber section 14 of the housing.

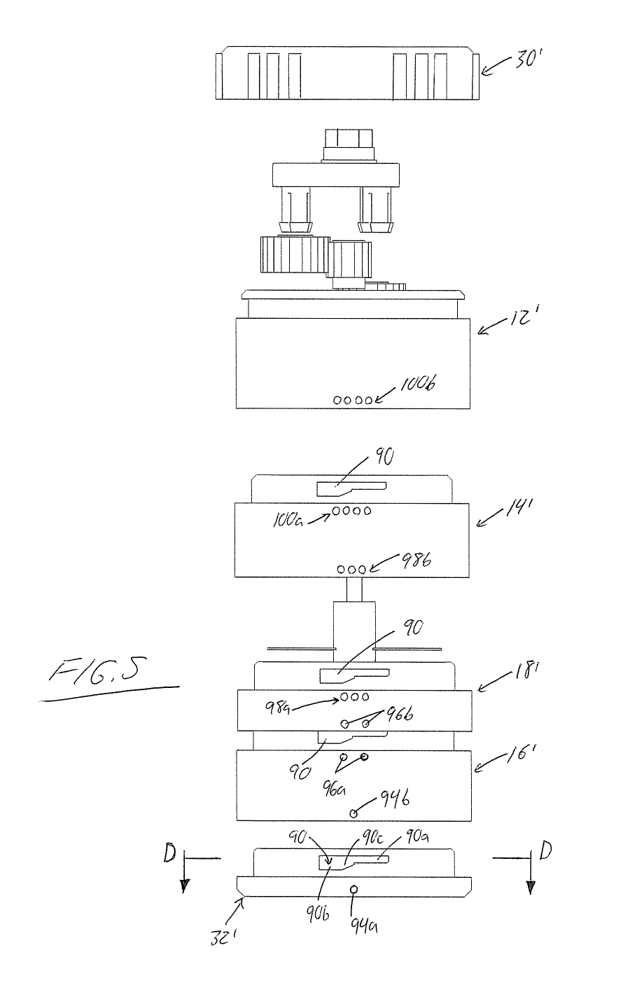

The input chamber section 14 includes an interior chamber like that of the drive section, but instead of a solid floor and solid closure disc that close off substantially the entire lower and upper ends of the chamber, the input section 14 features a pair of spoked dividers 70, 71 situated over and beneath its chamber. FIG. 4 illustrates the lower spoked divider 70 near the bottom end 14b of the input chamber section 14. Four planar spokes 72 extend radially outward from a central hub of the divider at the longitudinal axis, and each connect up with the circumferential wall 22 of the input chamber section 14. A central hole 74 in the hub of the spoked divider, as can be seen in FIG. 1, accommodates passage of the main shaft 68 therethrough. Open areas of the divider 70 between the spokes 72 allow herb material to pass therethrough during use of the grinder. The upper spoked divider 71 at the top end 14a of the input chamber section has the same general configuration as the lower divider 72, and thus is not illustrated or described in further detail.

The main shaft 68 passes through the central openings of both spoked dividers of the input chamber section 14 of the housing. The circumferential wall 22 of the input chamber section 14 is externally threaded at the top end 14a thereof the for removable coupling with mating internal threading on the circumferential wall of the drive section 12 at the lower end 12b thereof. The hexagonal top end of the main shaft 68 is axially slidable out of the mating recess in the sun gear to allow separation of the shaft from the drive section when the input chamber section is decoupled therefrom.

A lower set of blades 78 at the bottom end of the main shaft 68 radiate outwardly therefrom at a short distance beneath the lower divider 72, and in close proximity thereto. An upper set of blades 80 likewise radiate outwardly from the shaft 68 at a short distance above the lower divider 72, and in close proximity thereto. The first illustrated embodiment features four blades in each set, with the blades of each set arranged in radially opposing pairs that are spaced equally apart around the longitudinal axis 28, thus creating a cross-shaped four-blade configuration in each set, but the number and spacing of the blades may vary in either set. The upper and lower blade sets are shown as being angularly offset from one another about the longitudinal axis in the first illustrated embodiment, particularly so that the angular position of each blade around the longitudinal axis lies intermediately of two adjacent blades in the other set, but other positional relationships between the upper and lower blades may be employed. Each blade is generally planar in form, lying in a respective rotational plane normal to the longitudinal axis and having a thickness dimension in the axial direction of the container that is notably less than the length and width of the blade, as measured in its rotational plane. Although the first illustrated embodiment employs the same blade type and multi-blade configuration at the upper and lower sets, the upper and lower blade sets may differ from one another in other embodiments.

A retention clip 82 is engaged to the shaft 68 within a circumferential recess provided thereon just above the top divider 71 of the input chamber section 14. The clip 82 spans radially outward from the shaft axis by a distance exceeding the radial measure of the central hole in the top divider 71, thus preventing the top portion 68a of the shaft from falling through the central hole, and thereby preventing or limiting downward travel of the main shaft. Upward travel of the main shaft is limited or prevented by abutment of the top end of the shaft with the upper ceiling of the mating recess in the underside of the sun gear. Accordingly, the axial positions of the two blade sets in relation to the longitudinal axis, and thus the close positional relationship of the two blade sets to the lower spoked divider 70 between the blade sets, are maintained when the drive and input chamber sections are threaded together to slide the top end of the shaft into the sun gear.

The circumferential wall 24 of the intermediate housing section 18 is externally threaded at the top end 18a thereof the for removable coupling with mating internal threading on the circumferential wall 22 of the input chamber section 14 at the lower end 14b thereof. The intermediate housing section 18 is notably smaller in axial length than the other sections, its purpose being solely to support a perforated circular divider 84 spanning the area bound by the circumferential wall 24 of the intermediate section 18. An array of cylindrical through-holes 86 pass axially through the perforated divider at positioned spread thereover in a generally uniform manner.

The circumferential wall 26 of the output chamber section 16 is externally threaded at the top end 16a thereof the for removable coupling with mating internal threading on the circumferential wall 24 of the intermediate section 18 at the lower end 18b thereof, whereby the perforated divider 84 overlies the interior space of the output chamber section.

In the first illustrated embodiment, a removable base 32 is externally threaded at the top end 18a thereof the for removable coupling with mating internal threading on the circumferential wall 26 of the output chamber section 16 at the lower end 16b thereof. An end wall 88 of the base lying normal to the longitudinal axis defines a floor of the interior space of the output chamber section when the base is coupled thereto, whereby the internal space of the output chamber section 16 defines a respective chamber between the perforated divider 84 and the end wall of the base. The chamber of the output chamber section receives the ground herb product after the grinding operation, and thus is referred to as an output product chamber. The perforated divider divides the input product chamber from the output product chamber. The space between the lower spoked divider and the perforated divider defines a cutting or grinding area disposed intermediately of the two product chambers, in which the lower blade set operates in an intermediate plane lying normal to the longitudinal axis in this intermediate cutting or grinding area.

Having described the structure of the grinder, attention is now turned to its operation. As all of the drive sections are separable from one another by way of the threaded connections therebetween, loading of the unit with a herb or other product to be ground is enabled by unfastening the threaded connection between the drive section 12 and the input chamber section 14, and leaving the other housing sections 16, 18, or at least the intermediate section 18, attached to the input chamber section 14. The drive section 12 and rotatable cap are set aside, and are typically left assembled to one another, unless access to the drive components therein is required for service for repair. The user loads the unground initial product into the input chamber section, whose chamber is therefore referred to as an input chamber since this is where the product is initially introduced to the grinder. In its unground state, the initial product cannot pass through the openings 86 in the perforated divider, and thus cannot fall into the outlet chamber at the bottom of the container. Only once the product has been ground by the blades 78, 80 will it be in sufficiently small pieces to pass through the perforated divider.

The unground product will fit, at least partially, into the open areas between the upper blades 80. Once a desired amount of unground product has been placed in the input chamber, the input chamber section 14 is reattached to the drive section 12, thereby engaging the main shaft 68 of the grinding mechanism with the sun gear 48 of the drive mechanism. The user rotates the cap 30 of the container, thereby causing rotation of the blades 78, 80 via the gear train and main shaft 68. The rotational movement of the two sets of blades passing by the spokes of the lower spoked divider 70 in close proximity thereto, and the rotational movement of the lower set of blades over the topside of the perforated divider 84 in close proximity thereto, performs an effective grinding action by shearing through the herb product. The ground product, falls into the output chamber via the holes 86 of the perforated divider 84. To collect the final ground product, the output chamber section 16 is decoupled from the intermediate section 18, whereby the user can access the final product through the open top end 16a of the output chamber section 16.

For use in grinding marijuana, the output chamber section may optionally include an internal ledge at the perimeter of the output chamber for placement of a mesh screen thereon at a short height above the based-defined floor of the output chamber. The screen is useful for separating the resin glands or trichomes of cannabis from the dry cannabis flower. The resin glands will pass through the screen and be collectable from the base, while the larger flakes of the ground cannabis flower will collect atop the screen.

The grinder design using a rotatable cap as the drive input to the planetary gears of a planetary gear train allows the generation of significant blade speed to achieve an effective grinding action without the need for a powered drive source, and allows easy simple manipulation of the drive input with a comfortable circumferential grip for direct manual drive, or simple rolling of the cap over a surface of sufficient frictional contact to drive the grinding mechanism. The second roll-type mode actuation requires only the manual gripping of the stationary container sections 12, 14, 16, 18, with elbow and/or shoulder motion alone (without wrist movement) being sufficient to roll the container along a suitable surface. The disassembly of the various housing sections from one another enables easy, thorough cleaning of the input chamber, output chamber, and perforated divider, and the openable drive chamber allows easy service or repair of the drive components. However, embodiments with more permanent assembly techniques preventing disassembly of one more sections may also be used while still gaining benefit from the novel drive and blade configurations disclosed herein. Likewise, advantages of the drive mechanism details may be exploited in embodiments with different blade/grinder configurations, including embodiments in which the interior space of the housing isn't divided into separate input and output chambers.

Although the first illustrated embodiment features two blade sets for optimal performance, a prototype with only a lower set of blades disposed beneath the lower spoked divider was found to provide effective results. The prototype was manufactured using three-dimensional printing (also known as additive manufacturing), where all the housing sections, the rotational cap, the removable base, the shaft and blade combination, and even the gear carrier and gears can be each be produced as a single unitary seamlessly integral component of plastic material. Naturally, other materials and fabrication processes can of course be employed in the alternative for any one or more components.

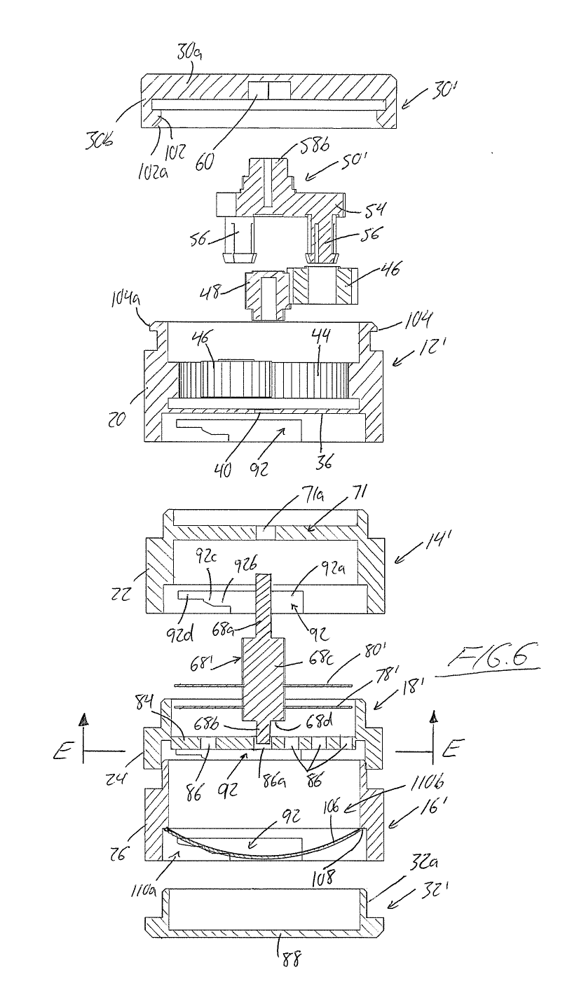

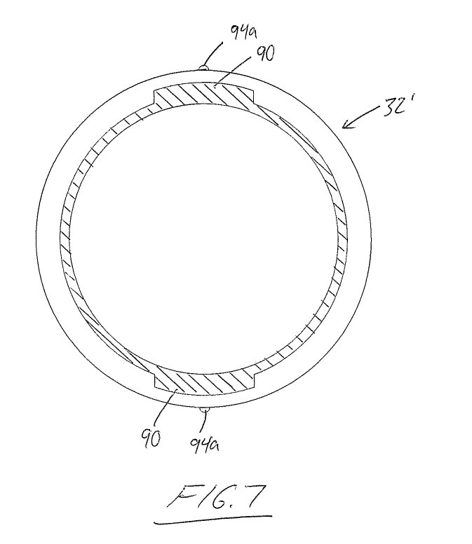

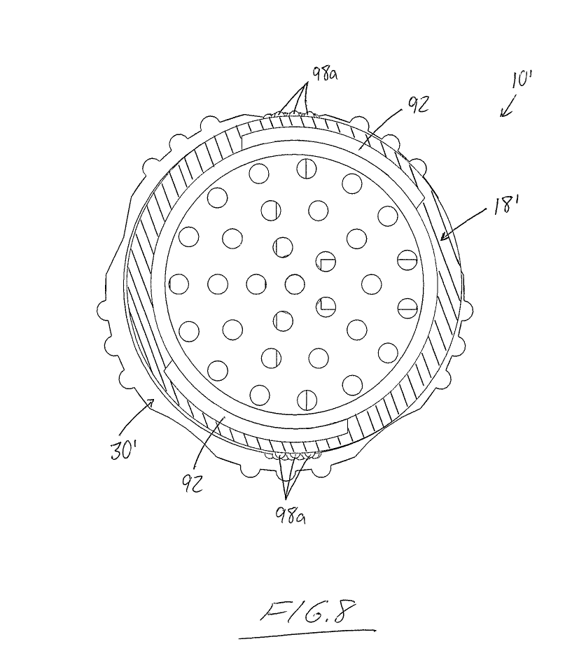

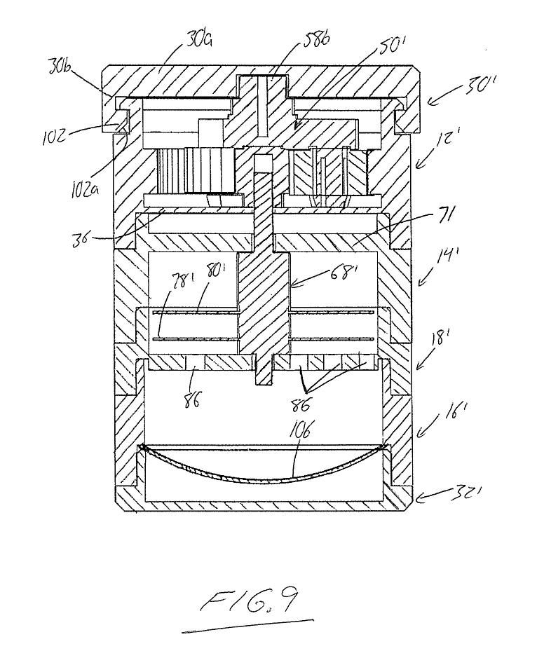

FIGS. 5 through 9 illustrate a second embodiment of the grinder, which once again features a housing made of a drive section 12′, an input chamber section 14′, an intermediate section 18′, and an output chamber section 16′ that are detachably coupled together end-to-end and finished off with a rotatable cap 30′ and a removable base 32′. Instead of having mating internal and external threading on mating ends of the housing sections, cooperating circumferential tabs and slots are defined on adjacent housing sections for locking of the housing sections together via mating of the tabs with the respective slots. With reference to FIGS. 5 and 7, the stepped-down male upper ends of the base 32′, output chamber section 16′, intermediate chamber section 18′ and the input chamber section 14′ all have a respective pair of circumferential male tabs 90 thereon that protrude radially outward from the stepped-down outer surface of the circumferential wall of the respective housing section. The radial extent of each such tab 90 does not project beyond the outer surface of the full-diameter lower half of the section's circumferential wall, which for each of the drive section 12′, input chamber section 14′, intermediate section 18′ and output chamber section 16′ defines a lower female end thereof. With reference to FIG. 6, each lower female end of the housing sections features a female circumferential slot 92 recessed into the peripheral wall of the housing from the inner surface thereof.

Turning back to FIG. 5, in a circumferential direction moving around the longitudinal axis of the container, each tab 90 varies in a thickness dimension that is measured in the axial direction of the container. Each tab 90 has a thin end segment 90a, a thicker end segment 90b lying there opposite in the circumferential direction of the container, and a ramped intermediate segment 90c residing between the end segments 90, 92. The top edges of the three tab segments are coplanar with one another in a plane lying normal to the container's longitudinal axis. The lower edges of the end segments lie in respective planes that are also normal to the container axis, while the lower edge of the intermediate segment 90c lies in an inclined plane to define a sloped ramp that joins the lower edges of the two end segments together.

With reference to FIG. 6, each circumferential slot 92 likewise has a varying thickness profile over its circumferential length around the longitudinal axis of the container. More specifically, each slot 92 has a thickest portion 92a which is open in the axial direction at the terminus of the lower female end of the housing section, a thin portion 92b extending circumferentially from the thickest portion 92a and closed off at the terminus of the lower female end of the housing section, a ramped intermediate portion 92c that grows even thinner moving away from the thin portion 92b to a final thinnest portion 92d that is situated at an end of the slot 92 opposite the thickest portion 92a in the circumferential section. The top edges of the different sections of the slot 92 are coplanar with one another in a plane lying normal to the container's longitudinal axis. The lower edges of the thin and thinnest sections 92b, 92d lie in respective planes that are normal to the container axis, while the lower edge of the intermediate section 92c lies in an inclined plane to define a sloped ramp that joins the lower edges of the thin and thinnest segments 92b, 92d.

The circumferential length of the thickest portion 92a of each slot slightly exceeds the entire circumferential length of the respective tab 90, whereby each tab 90 can be axially displaced into the respective slot 92 at the axially-open thickest portion 92a thereof when the longitudinal axes of the two housing sections are brought into coincident alignment with one another. After sufficient displacement to bring the flat upper edge of the tab 90 against the flat upper edge of the slot 92, the two housing sections are then rotated relative to one another about their shared longitudinal axis, thereby sliding the thinnest portion 90a of each tab 90 circumferentially around the container axis into the thinnest portion 92d of the respective circumferential slot 92. The inclination angle of the ramped areas of the tab and the slot match one another, and the circumferential length of the thinnest portion 92d of the slot exceeds that of the thinnest segment 90a of the tab, whereby sufficient sliding of the tab circumferentially along the slot under relative rotation of the housing sections moves the ramped segment 90c of the tab into sliding contact with the ramped portion 92c of the slot, whereupon the ramped segment 90c of the tab rides upwardly along the ramped portion 92c of the slot, thus forcing the upper edge of the tab against the upper edge of the slot, and thereby wedging the tab into a frictionally locked state in the tapered or ramped portion of the slot 92. With the tab 90 engaged in this manner into the closed-bottomed portions 92b, 92c, 92d of the slot 90, the bottom edges of these closed-bottom portions 92b, 92c, 92d of the slot 92 block axial withdrawal of the tab 90 therefrom, thus axially locking the two housing sections together. In the illustrated embodiment employing these cooperating male and female locking features, each pair of mated together ends of the housing sections features two diametrically opposite slots on one of the housing sections and two diametrically opposite tabs on the other. However, it will be appreciated that the number of tab-slot pairs may be varied.

For each pair of mating ends of the housing sections at which the cooperating tabs and slots are operable to lock the two adjacent housing sections together, at least one pair of matching indicators are defined on the outer surfaces of the circumferential walls of these adjacent housing sections. With reference to FIG. 5, one such pair of matching indicators is provided in the form of a one-dot marker 94a on the base 32′ and a matching one-dot marker 94b at the female lower end of the output chamber section 16′ of the housing′. Another such pair of matching indicators is provided in the form of a two-dot marker 96a near the upper male end of the output chamber section 16′ and a matching two-dot marker 96b at the female lower end of the intermediate section 18′. Another such pair of matching indicators is provided in the form of a three-dot marker 98a near the male upper end of the intermediate chamber section 16′ and a matching three-dot marker 98b at the female lower end of the inlet chamber section 14′. A final pair of matching indicators is provided in the form of a four-dot marker 100a near the male upper end of the inlet chamber section 14′ and a matching four-dot marker 100b at the female lower end of the drive section 12′. By matching the indicator on one piece of the housing with the indicator having the same number of dots on another piece of the housing, a user knows which piece connects to which, and at which end thereof. The indicators thereby provide the user with guidance on a proper assembly sequence for the housing.

In the illustrated embodiment, each tab 90 and each slot 92 has a respective one of the indicators situated adjacent thereto at the outer surface of the circumferential wall of the respective housing section. As such, at each pair of mating ends of the housing section, there is a set of four matching indicators, one for each of the two slots on one of the housing sections and one for each of the two tabs on the other of the housing sections. Due to the positioning of each indicator at the same angular position around the longitudinal axis as a respective one of the tabs or slots, the indicators not only serve as guides to the assembly order of the housing, but also provide feedback on whether adjacent housing sections have been properly locked together by engagement of the respective set of slots and tabs. By aligning the indicator on one housing section with the matching indicator on the adjacent housing, a user achieves an aligned state between each of the tabs 90 on the one housing section and the axially-open portion 92c of the respective slot 92 on the other housing section to enable axial sliding of the tabs into the slots. Subsequent relative rotation of the two housing sections to drive the tabs and slots into locked engagement displaces the indicator on the one housing section circumferentially away from the matching indicator on the other housing section.

Accordingly, visual or tactile detection of the mis-aligned state of these two matching indicators provides the user with confirmation that the two housing sections have been properly locked together. Rotation between the housing sections in the reverse direction, returning the tab to the axially-open thickest portion 92a of the respective slot causes the indicators to return into their aligned state, thereby providing the user with tactile or visual confirmation that the two housing sections have been unlocked, and are now axially separable from one another for disassembly of the container.

In the illustrated embodiment, each indicator is defined by a number of markings in the form of raised circular dots spherically protruding from the outer surface of the housing's circumferential wall, but it will be appreciated that markings of other shape or configuration may similarly be employed, whether those markings are raised or recessed relative to the circumferential wall surface of the container so as to provide a tactile marking that can be felt by the user's hands or fingertips, or whether the markings are merely printed or otherwise imposed on the container in a manner providing visual confirmation, but little or no tactile detectability.

The input chamber section 14′ of the housing of the second embodiment also differs from the first embodiment in that it lacks a lower spoked divider 70, instead only having upper spoked divider 71 near its upper end. The grinding mechanism once again has two sets of blades 78′, 80′ on its main shaft 68′, but differs from the first embodiment in few ways. The lower set of blades 78′ are spaced upwardly from the lower end of the main shaft 68′, and the shaft 68′ has an enlarged intermediate portion that spans a notable length of its longitudinal dimension and has a greater diameter than smaller stub portions of the shaft above and the below this enlarged intermediate portion. Like in the first embodiment, the upper portion 68a of the shaft is hexagonally configured for receipt in the mating recess in the underside of the sun gear 48.

The shaft 68′ is not suspended from the spoked upper end of the input chamber section using the retention clip of the first embodiment. Instead, a cylindrically shaped lower portion 68b of the shaft located beneath the enlarged intermediate portion 68c is received within a central one of the cylindrical through-holes 86 in the perforated divider 84 of the intermediate section 18′ of the housing. A downward facing shoulder 68d of the shaft 68 defined between the lower and intermediate portions thereof rests atop the spoked divider 84, as the diameter of the intermediate shaft portion 68c exceeds the diameter of the central through-hole 86a of the perforated divider. The blade sets 78′, 80′ of the grinding mechanism project radially outward from the intermediate shaft portion 68c above the perforated divider 84 at respective intermediate cutting planes at the grinding area between the input and output chambers. Each blade set 78′ features two generally rectangular, radially opposing blades extending from opposite sides of the shaft 68′ in a cutting plane lying normal to the axis of the shaft. Each blade is sharpened at both of its two parallel edges extending longitudinally of the blade (i.e. outwardly away from the shaft).

During assembly of the grinder, the user inserts the cylindrical lower stub shaft portion 68b of the shaft 68′ into the center hole 86a of the perforated divider 84 of the intermediate housing section 18′, and assembles the input chamber section 14′ thereto so as to pass the hexagonal upper portion 68a of the shaft through the central opening in the upper spoked divider 71 for receipt of the shaft's upper end in the sun gear 48. During disassembly of the housing, when the input chamber section is uncoupled from the intermediate section, there is nothing present to hold the main shaft 68′ in engagement with the sun gear, and the upper shaft portion 68a will simply fall free of the sun gear through the openings 40, 71a in the drive section's floor 36 and the input chamber's spoked divider 71. Accordingly, this automatic freeing of the shaft from the sun gear disengages the blades from the drive components so as to prevent injury due to inadvertent rotation of the cap 30′ when the blades are exposed by the removal of the intermediate housing section 18′.

Another distinction of the second embodiment from the first is that the cap 30′ lacks a central opening by which it is fastened to the gear carrier 52. Instead, the cap features an in-turned flange 102 at the lower end of its peripheral wall 30b which catches under a corresponding out-turned flange 104 at the upper end 12a of the drive section 12′ of the housing. This snap fit assembly of the drive section and cap is performed a factory setting, whereby the drive components are permanently enclosed within the drive section, or at least not easily removed therefrom in a manual unaided fashion, so as to avoid inadvertent loss of any drive components that could otherwise result from user-disassembly of the cap and drive section.

The in-turned and out-turned flanges 102, 104 of the cap and drive section are cooperatively beveled to ease the assembly thereof. The beveled inside-lower edge 102a of the cap's in-turned flange rides outwardly over the beveled outside upper edge 104a of the drive section's out-turned flange to momentarily flex the cap's peripheral wall outwardly to enable sliding of the cap's flange downwardly past the drive section's flange, whereupon the cap's flange will snap back into place in order to catch underneath the flanged upper end of the drive section.

Since the cap of the second embodiment is permanently mounted to the container, or at least not easily removed therefrom, a separate closure disc 34 for enclosing the interior space of the drive section is omitted in the second embodiment. In the event that removal of the cap does become necessary, removal thereof may be enabled by application of heat to the cap (e.g. with a heat gun or hair dryer) to cause radial expansion of its lower end and allow lifting of the in-turned cap flange upwardly past the out-turned flange of the drive section to free the cap. Such tool-aided removable of the cap enables replacement, cleaning, greasing or other servicing to the internal drive components. The second embodiment features raised ribs 106 running in the axial direction of the housing at the exterior surface of the cap's peripheral wall for easier manual gripping or improved frictional engagement during operation of the grinder through rotational motion of the cap.

The second embodiment includes a screen 106 supported in the output chamber beneath the perforated divider 84. An interior shoulder 108 projects inwardly toward the central longitudinal axis of the housing at a radial transition between a larger diameter lower portion 110a of the output chamber and a smaller diameter upper portion thereof 110b. The screen 106 resides in the larger diameter lower portion 110a of the output chamber, and has a diameter exceeding that of the smaller diameter upper portion 110b of the output chamber. A reduced-diameter hollow upper portion 32a of the base 32′ fits within the lower end of the drive chamber, and has an outer diameter greater which is than the inner diameter of the smaller-diameter upper portion 110b of the output chamber. The axial length of the reduced-diameter upper portion 32a of the base 32′ generally equals the axial length of the enlarged-diameter lower portion 110a of the output chamber section 16′, and the mating tabs and slots between the base 32′ and the output chamber section 16′ are positioned so that the reduced-diameter upper portion 32a of the base 21′ resides substantially entirely within the enlarged diameter lower end 110a of the output chamber. As a result, the upper end 32a of the base forces the outer perimeter of the screen 106 against the interior shoulder 108 of the output chamber section 16′, thereby clamping the screen 106 in place between the output chamber section and the base. Accordingly, the screen 106 is easily removable for cleaning or replacement by simple removable of the base from the output chamber section via a turn-and-pull action disengaging and removing the tabs of the base from the slots of the output chamber section. As shown, the screen may have a generally spherical contour, with a concave side thereof facing upwardly toward the perforated divider 84 at an axially spaced distance therefrom. The hollow upper portion 32a of the base may be used to store a small cleaning brush useable to clean the screen 106 or other parts of the grinder when the base 32′ is removed to gain access to this storage space.

Since various modifications can be made in my invention as herein above described, and many apparently widely different embodiments of same made within the scope of the claims without departure from such scope, it is intended that all matter contained in the accompanying specification shall be interpreted as illustrative only and not in a limiting sense.

1. A manually operable grinder comprising:
a housing comprising:
a drive chamber for housing drive components;
a product chamber for containing a product;
a rotatable upper cap at an upper end of the housing and rotatable relative thereto about a longitudinal thereof;
a gear carrier comprising:
a drive end coupled to the rotatable upper cap for driven rotation of the gear carrier about the longitudinal axis under rotation of the upper cap; and
inside the drive chamber, a plurality of stub shafts spaced angularly apart from one another about the longitudinal axis in orientations lying parallel thereto;
a gear train comprising:
a respective planetary gear disposed about each stub shaft in a manner rotatable about an axis thereof;
a sun gear disposed within the interior space of the drive section at a position centred on the longitudinal axis and in engagement with the plurality of planetary gears;
a ring gear located inside the drive chamber at a position centered around the longitudinal axis with teeth of said ring gear facing inwardly toward the longitudinal axis in engagement with the plurality of planetary gears;
a main shaft having an upper end coupled to the sun gear for rotation therewith and extending downward therefrom into the product chamber; and
at least one blade coupled to the main shaft and radiating outwardly therefrom for rotation therewith, whereby rotation of the end cap rotates the gear carrier in order to drive rotation of the main shaft and the at least one blade via the gear assembly in order to perform a grinding operation on the product in the product chamber.

2. The grinder of claim 1 wherein the drive chamber is defined by a respective drive section of the housing that is removably coupled to one or more product chamber sections defining the product chamber.

3. The grinder of claim 1 wherein the product chamber is divided into input and output chambers, the input chamber being disposed adjacent the drive chamber for receiving a product in an unground state, and the output chamber being disposed across the input chamber from the drive chamber in order to receiving the product in a ground state after performance of the grinding operation on the product by the at least one blade.

4. The grinder of claim 3 wherein the input and output chambers are respectively defined by input and output chamber sections of the housing that are removably coupled to one another.

5. The grinder of claim 3 wherein the input chamber comprises a spoked divider that is located adjacent an upper end thereof that resides opposite the output chamber, the spoked divider comprises a series of spokes radiating outwardly away from the longitudinal axis toward the circumferential wall of the input chamber section at angularly spaced locations around the longitudinal axis leaving open areas between said spokes, and the at least one blade comprises one or more blades residing between the spoked divider and the output chamber.

6. The grinder of claim 5 wherein said one or more blades comprise two sets of blades disposed in different respective cutting planes, each set of blades comprising a pair of radially opposing blades.

7. The grinder of claim 6 wherein each set of blades consists only of said pair of radially opposing blades.

8. The grinder of claim 5 wherein said one or more blades residing between the spoked divider and the output chamber are the only blades of the grinder.

9. The grinder of claim 3 comprising a perforated divider located between the input and output chambers to allow entry of the ground product to the interior space of the output chamber section while preventing entry of the unground product thereto.

10. The grinder of claim 9 wherein the perforated divider is defined by a removable divider section of the housing that is coupled between the output chamber and the input chamber.

11. The grinder of claim 9 wherein the perforated divider comprises a central opening therein in which the main shaft is received.

12. The grinder of claim 11 wherein the central opening of the perforated divider is a through-hole, and the main shaft comprises an enlarged intermediate portion located above the perforated divider and having a greater diameter than the central opening of the perforated divider to block sliding of the main shaft downwardly through said central opening and thereby locate the at least one blade at a spaced distance from said perforated divider.

13. The grinder of claim 1 comprising a removable base at the lower end of the housing.

14. The grinder of claim 1 comprising a screen mounted within the product chamber below the at least one blade.

15. The grinder of claim 13 comprising a screen clamped in place between the removable base and an adjacent section of the housing to which the removable base is detachably coupled.

16. The grinder of claim 1 wherein the housing comprises a plurality of detachable sections removably coupled to one another, the detachable sections comprising distinct sets of indicators thereon that provide guidance to a sequential order of the detachable sections in an assembled state of the housing.

17. The grinder of claim 16 wherein each set of indicators comprises at least one pair of matching indicators defined on an adjacent pair of the detachable sections.

18. The grinder of claim 16 wherein each indicator comprises a one or more markings, and the distinct sets of indicators are distinguished from one another by a quantity of the one of more markings in each indicator of the set.

19. The grinder of claim 16 wherein aligned and misaligned states between the indicators of each set distinguish between an engaged and disengaged state between coupling features of a respective pair of matable ends of the detachable sections.

20. The grinder of claim 19 wherein the coupling features of each pair of matable ends of the detachable sections comprise a circumferential tab on one of the detachable sections and a corresponding circumferential slot on another of the detachable sections, the tab being axially insertable into the circumferential slot by relative axial displacement between the detachable sections, and circumferentially slidable along the circumferential slot by relative rotation between the detachable sections to engage and disengage the detachable sections to and from one another.

21. The grinder of claim 1 wherein the housing comprises a plurality of detachable sections removably coupled to one another, and the main shaft is maintained in position solely by a coupled-together state of the detachable sections such that disassembly of the housing automatically releases the main shaft and the at least one blade.

22. A manually operable grinder comprising:
a housing comprising a plurality of housing sections each having an upper end and an opposing lower end and a circumferential wall spanning around a longitudinal axis of the housing to enclose an interior space of said housing section between the upper and lower ends thereof, the plurality of housing sections comprising:
a drive section for housing drive components;
an input chamber section for receiving a product in an unground state, the upper end of the input chamber section being coupled to the lower end of the drive section; and
an output chamber section for receiving the product in a ground state after a grinding operation;
a rotatable upper cap disposed over the upper end of the drive section and rotatable relative thereto about the longitudinal axis;
a gear carrier comprising:
a drive end coupled to the rotatable upper cap for driven rotation of the gear carrier about the longitudinal axis under rotation of the upper cap; and
inside the interior space of the drive section of the housing, a plurality of stub shafts spaced angularly apart from one another about the longitudinal axis in orientations lying parallel thereto;
a gear system comprising:
a respective planetary gear disposed about each stub shaft in a manner rotatable about an axis thereof;
a sun gear disposed within the interior space of the drive section at a position centred on the longitudinal axis and in engagement with the plurality of planetary gears;
a ring gear located inside the interior space of the drive section a position centered around the longitudinal axis with teeth of said ring gear facing inwardly toward the longitudinal axis in engagement with the plurality of planetary gears;
a main shaft having an upper end coupled to the sun gear for rotation therewith and extending downward therefrom into the input chamber section; and
at least one blade coupled to the main shaft and radiating outwardly therefrom for rotation therewith, whereby manual rotation of the end cap rotates the gear carrier in order to drive rotation of the main shaft and the at least one blade via the gear assembly in order to perform the grinding operation on the unground product in the input product chamber in order to create the ground product in the output product chamber.

23. A grinder comprising:
a housing comprising an input chamber receiving a product in an unground state, and an output chamber section for receiving the product in a ground state after performance of a grinding operation;
a shaft lying on a longitudinal axis the housing;
a drive mechanism coupled to the shaft and operable to drive rotation thereof about the longitudinal axis;
at least one blade coupled to the main shaft and radiating outwardly therefrom for rotation therewith at an intermediate plane disposed between the input chamber and the output chamber;
a first divider located above the intermediate plane in which the at least one blade resides;
a second divider below the intermediate plane in which the at least one blade resides;
wherein the first divider has openings therein of a first size and the second divider has openings therein of a smaller second size such that unground product can reach the intermediate plane through the openings of the first size for performance of a grinding operation of the unground product by said blades, but the unground product cannot pass through the openings of the second size to the output chamber until ground into smaller pieces by the at least one blade of the intermediate plane.

24. The grinder of claim 23 wherein the first divider comprises a spoked divider comprising a series of spokes radiating outwardly away from the longitudinal axis toward a circumferential wall of the input chamber at angularly spaced locations around the longitudinal axis, and the openings of the first size comprise open areas between said spokes.

25. The grinder of claim 23 wherein the second divider comprises plurality of cylindrical through-bores arrayed over an area of said second divider.

26. A grinder comprising:
a housing comprising a plurality of housing sections each having an upper end and an opposing lower end and a circumferential wall spanning around a longitudinal axis of the housing to enclose an interior space of said housing section between the upper and lower ends thereof, the plurality of housing sections comprising a drive section for housing drive components and a product chamber for containing a product;
a main shaft having an upper end coupled to the drive components in the drive section and extending downward therefrom into the product chamber; and
at least one blade coupled to the main shaft and radiating outwardly therefrom for rotation therewith, whereby driven rotation of the main shaft performs a grinding operation on the product in the product chamber;
wherein the detachable sections comprising distinct sets of indicators thereon that provide guidance to a sequential order of the detachable sections in an assembled state of the housing.

27. A grinder comprising:
a housing comprising a plurality of housing sections each having an upper end and an opposing lower end and a circumferential wall spanning around a longitudinal axis of the housing to enclose an interior space of said housing section between the upper and lower ends thereof, the plurality of housing sections comprising a drive section for housing drive components and a product chamber for containing a product;
a main shaft having an upper end coupled to the drive components in the drive section and extending downward therefrom into the product chamber; and
at least one blade coupled to the main shaft and radiating outwardly therefrom for rotation therewith, whereby driven rotation of the main shaft performs a grinding operation on the product in the product chamber;
wherein the main shaft is maintained in position solely by a coupled-together state of the detachable sections such that disassembly of the housing automatically releases the main shaft and the at least one blade.

28. A grinder comprising:
a housing comprising a plurality of housing sections each having an upper end and an opposing lower end and a circumferential wall spanning around a longitudinal axis of the housing to enclose an interior space of said housing section between the upper and lower ends thereof, the plurality of housing sections comprising a drive section for housing drive components and a product chamber for containing a product;
a main shaft having an upper end coupled to the drive components in the drive section and extending downward therefrom into the product chamber;
at least one blade coupled to the main shaft and radiating outwardly therefrom for rotation therewith, whereby driven rotation of the main shaft performs a grinding operation on the product in the product chamber; and
coupling features defined at matable ends of the detachable sections for attaching adjacent sections to one another in an assembled state of the housing, said coupling features comprising a circumferential tab on one of the detachable sections and a corresponding circumferential slot on another of the detachable sections, the tab being axially insertable into the circumferential slot by relative axial displacement between the detachable sections, and circumferentially slidable along the circumferential slot by relative rotation between the detachable sections to engage and disengage the detachable sections to and from one another.
